(19) United States
(12) Patent Application Publication
(10) Pub. No.: US 2009/0291591 A1
(43) Pub. Date: Nov. 26, 2009

(54) Wave filter structure

(76) Inventors: Shun-Ho Chung, Yung Kang City (TW); Chih-Pin Yao, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,454

(22) Filed: May 20, 2008

(51) Int. Cl. H01R 13/648

(52) U.S. Cl. 439/607.01

(57) ABSTRACT

A wave filter includes a shell, a wave filter circuit board in the shell, a cover secured over a holding room of the shell, and a grounding component interposed between the circuit board and the cover; the shell has several detainment gaps on an upper end of its surrounding wall; the circuit board has several grounding holes; the cover has several joining protrusions on its periphery, and is joined on the shell with the joining protrusions being tightly embedded in corresponding detainment gaps on the shell; the grounding component has several grounding terminals, which are embedded in corresponding grounding holes of the circuit board; the grounding component has several joining protrusions on a periphery, which are embedded in corresponding detainment gaps; thus, the circuit board will be directly grounded through the grounding component and the shell after assembly without applying solder between the circuit board and the shell.

### BACKGROUND OF THE INVENTION

1. Field of the Invention

The present invention relates to a wave filter structure, more particularly one, which includes a shell, a wave filter circuit board, and a cover, and further includes a grounding component to ground the circuit board directly without using solder; the grounding component is interposed between and in contact with the circuit board and the cover, and has peripheral protrusions, which are embedded in detainment gaps of a surrounding wall of the shell like joining protrusions of the cover; the grounding component has grounding terminals, which are tightly embedded in grounding holes of the wave filter circuit board in order for the circuit board to be grounded through the shell without solder being applied between the circuit board and the shell.

2. Brief Description of the Prior Art

It is a new development trend of home networking to combine digital products with computers and digital multimedia equipments. Wireless Local Area Network (WLAN), Ultra-Wide Band (UWB), HomePlug, and Multimedia over Coax Alliance (MOCA) are among the currently existing technologies of home networking. The Multimedia over Coax Alliance (MOCA) was established by its founding members in January 2004, and develops specifications for home networking over in-home co-axial cable. The goal of the Multimedia over Coax Alliance is to facilitate home networking on existing coaxial cables, which can be used for data connections to telephones, World Wide Web, set top boxes, cable TV (CATV), Satellite Master Antenna Television System (SMATV), Wireless Local Area Network (WLAN) and other entertainment devices without the need for new connections, thus providing people with more convenience.

Various kinds of signals transferred through coaxial cables have to be filtered with wave filters to acquire needed bands after they have been input into a multimedia broadband router. Referring to FIG. 4 to FIG. 6, a currently existing wave filter 5 includes a shell 51, a wave filter circuit board 52, and a covering 53. The shell 51 has a holding room 511 therein, and several supporting pieces 512 protruding to the holding room 511 from an inner side thereof. The wave filter circuit board 52 is positioned in the holding room 511, and propped on the supporting pieces 512 on the inner side of the shell 51. The wave filter circuit board 52 is grounded with a grounding terminal 521 thereof being firmly joined to the inner side of the shell 51 by means of soldering. The shell 51 has several detainment gaps 513 on an upper end of a surrounding wall portion thereof. The covering 53 has several joining protrusions 531 on a periphery thereof. In assembly, the covering 53 is positioned over the holding room 511 with the joining protrusions 531 being embedded in the detainment gaps 513 of the shell 51. Next, those portions of the shell 51 that are on two sides of the detainment gaps 513 are pressed and bent so as to come into contact with two sides of the joining protrusions 531 of the covering 53 by means of a punch; thus, the covering 53 is firmly fixed on the top of the shell 51. And, connecting terminals 514 are fitted on an outer side of the shell 51 for connection with coaxial cables.

The wave filter can be easily connected to coaxial cables for use. However, it is relatively environment-unfriendly, and takes much time and labor to ground the wave filter because the wave filter circuit board is grounded with its grounding terminal being joined to the inner side of the shell by means of applying solder to the joint between the grounding terminal and the shell, which can pollute the environment if not properly disposed.

Therefore, it is a main object of the present invention to provide an improvement on a wave filter structure, which is environmentally friendly, to overcome the above problems.

### SUMMARY OF THE INVENTION

A wave filter in accordance with an embodiment of the present invention includes a shell, a wave filter circuit board in the shell, a cover secured over a holding room of the shell, and a grounding component interposed between the circuit board and the cover. The shell has several detainment gaps on an upper end of its surrounding wall. The wave filter circuit board has several grounding holes. The cover has several joining protrusions on its periphery, and is joined on the shell with the joining protrusions being tightly embedded in corresponding said detainment gaps on the shell. The grounding component has several grounding terminals, which are embedded in corresponding said grounding holes of the circuit board. The grounding component further has several joining protrusions on its periphery, which are embedded in corresponding said detainment gaps. Thus, the circuit board will be directly grounded after assembly without environment-unfriendly solder being used between the circuit board and the shell.

### BRIEF DESCRIPTION OF THE DRAWINGS

The present invention will be better understood by referring to the accompanying drawings, wherein:

FIG. 1 is an exploded perspective view of the present invention,

FIG. 2 is a sectional view of the present invention,

FIG. 3 is a partial sectional view of the present invention,

FIG. 4 is an exploded perspective view of the prior art,

FIG. 5 is a sectional view of the prior art, and

FIG. 6 is a partial sectional view of the prior art.

### DETAILED DESCRIPTION OF THE PREFERRED EMBODIMENTS

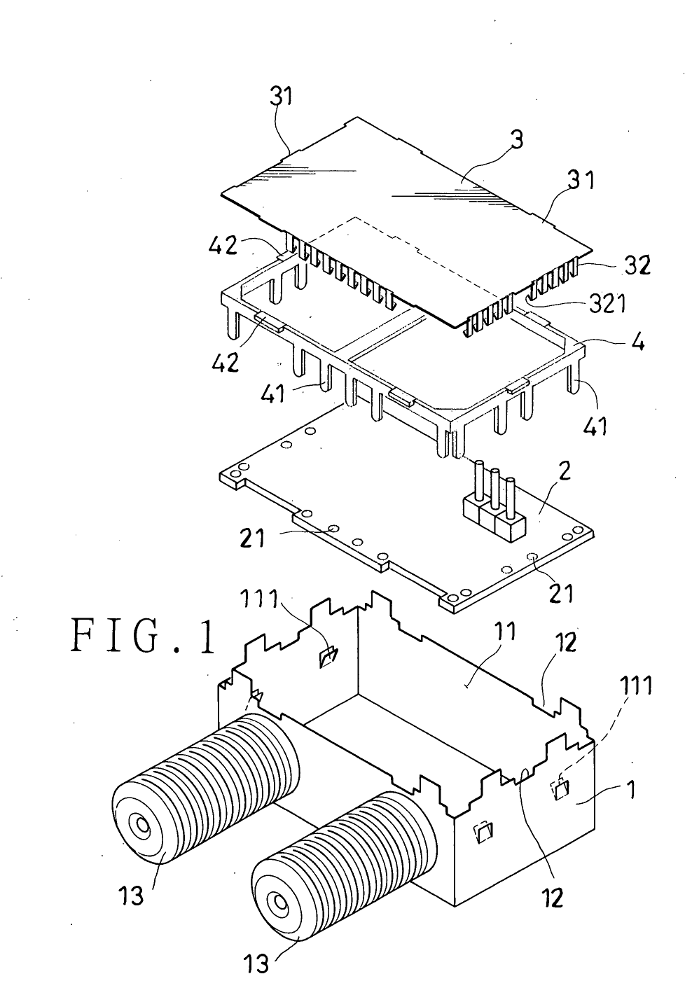

Referring to FIG. 1, a preferred embodiment of a wave filter of the present invention includes a shell 1, a wave filter circuit board 2, a cover 3, and a grounding component 4.

The shell 1 has a holding room 11 therein, several supporting pieces 111 protruding to the holding room 11 from an inner side thereof, and several detainment gaps 12 on an upper end of a surrounding wall portion thereof. And, connecting terminals 13 are fitted on an outer side of the shell 1 for connection with coaxial cables.

The wave filter circuit board 2 is positioned in the holding room 11, and propped on the supporting pieces 111 on the inner side of the shell 1. The wave filter circuit board 2 has several grounding holes 21 thereon.

The cover 3 has several joining protrusions 31 on a periphery thereof, and it is positioned over the holding room 11 with the joining protrusions 31 being embedded in the detainment gaps 12 of the shell 1. The cover 3 further has propping and pressing pieces 32 protruding downwards from the periphery. Each of the propping and pressing pieces 32 has an elastic propping and pressing portion 321 at a lower end.

The grounding component 4 is interposed between the wave filter circuit board 2 and the cover 3, and has several grounding terminals 41 joined in corresponding said grounding holes 21 of the wave filter circuit board 2. The grounding component 4 further has several joining protrusions 42 on a periphery thereof to be received in corresponding said detainment gaps 12 of the shell 1.

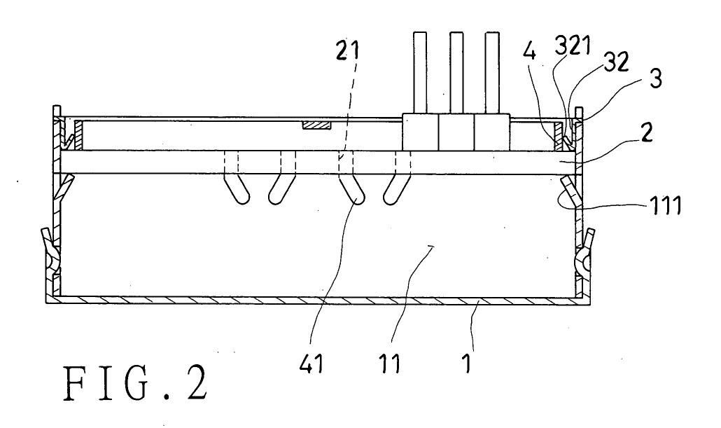

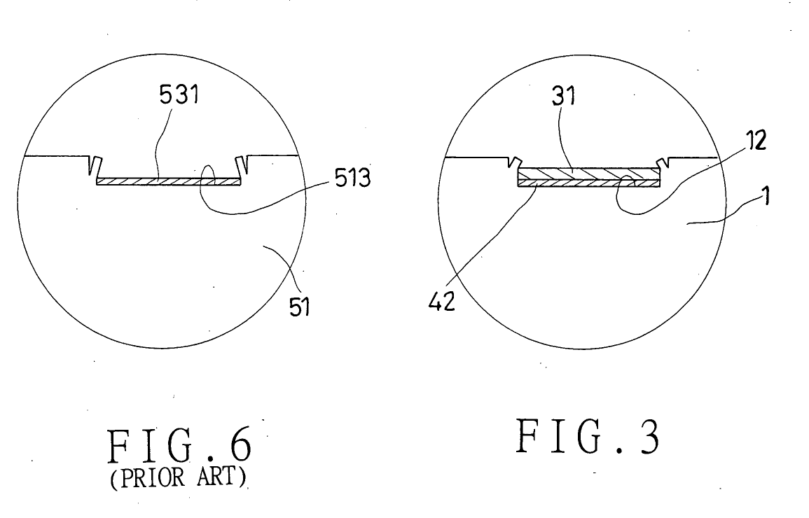

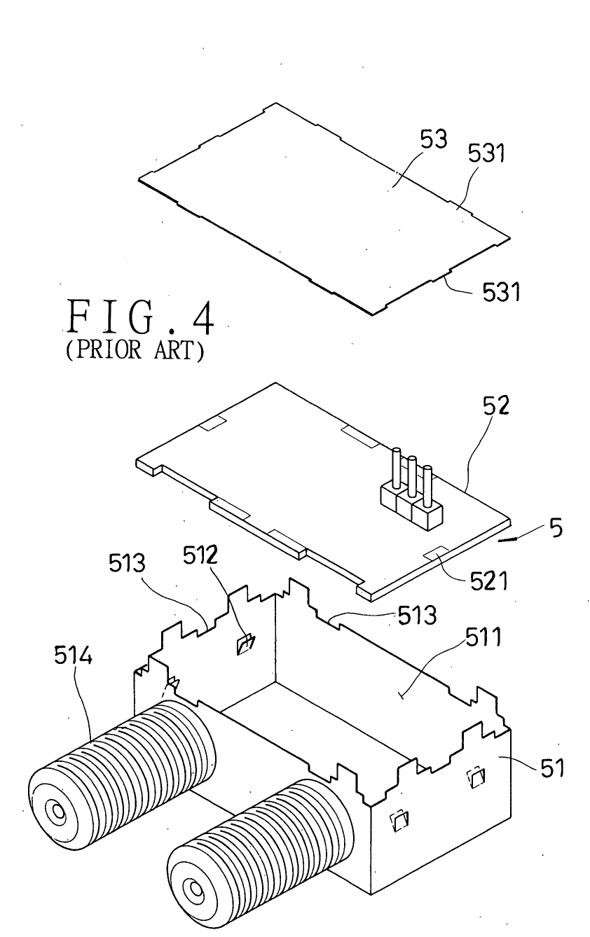

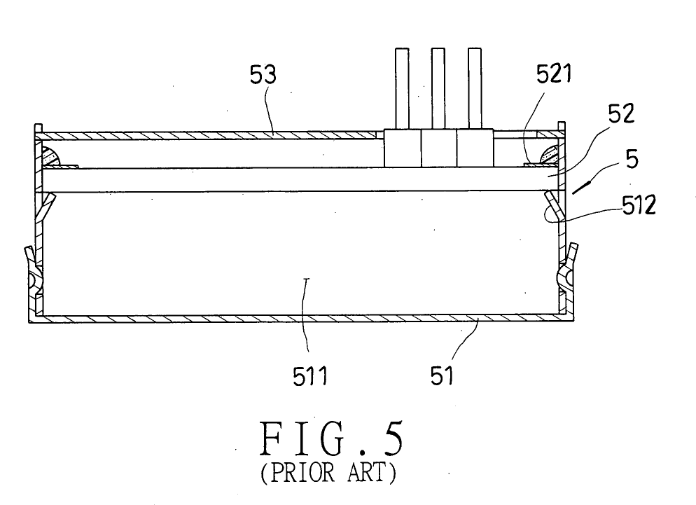

In assembly, referring to FIGS. 2 and 3, first the wave filter circuit board 2 is positioned in the holding room 11, and propped on the supporting pieces 111 on the inner side of the shell 1. Next, the grounding component 4 is pressed against an upper side of the wave filter circuit board 2, with the grounding terminals 41 being inserted in respective ones of the grounding holes 21 of the circuit board 2 and with the joining protrusions 42 being received in the detainment gaps 12 of the shell 1. The grounding terminals 41 are preferably slightly bent so as to be tightly embedded in the grounding holes 21 in the assembling process; thus, the grounding terminal 4 can be firm on the wave filter circuit board 2. Next, the cover 3 is positioned on an upper side of the grounding component 4, with the joining protrusions 31 of the cover 3 being received in the detainment gaps 12 of the shell 1, and with the propping and pressing pieces 32 being inserted between the grounding component 4 and the shell 1, and the elastic propping and pressing portions 321 being constantly in contact with both the grounding component 4 and the shell 1 so as to prevent the grounding component 4 from shaking relative to the wave filter circuit board 2; thus, there is a constant electrical connection, and the present wave filter is certainly grounded. Then, those portions of the shell 1 that are on two sides of the detainment gaps 12 are pressed and bent so as to come into contact with two sides of the joining protrusions 31, 42 of the cover 3 and the grounding component 4 by means of a punch; thus, the cover 3 and the grounding component 4 are firmly fixed in position. Therefore, the wave filter circuit board 2 will be directly grounded through the grounding component 4 and the shell 1 after assembly, with the grounding terminals 41 being tightly embedded in the grounding holes 21 of the wave filter circuit board 2, and the joining protrusions 42 of the grounding component 4 being tightly inserted in the detainment gaps 12 of the shell 1.

From the above description, it can be easily seen that the present invention has an advantage over the prior art: The wave filter circuit board has grounding holes, and the grounding component is joined on the circuit board with its grounding terminals being tightly embedded in the grounding holes, and the cover is fixed above to the grounding component to ensure constant electrical connection between the shell and the grounding component. Consequently, the wave filter of the present invention will be directly grounded through the grounding component and the shell after assembly without potentially environment-polluting solder being applied to the joint between the wave filter circuit board and the shell, and the present invention is practical and environment friendly.

What is claimed is:

1. A wave filter structure, comprising
a shell; the shell having a holding room therein; the shell having a plurality of supporting pieces protruding to the holding room from an inner side thereof; the shell having a plurality of detainment gaps on an upper end of a surrounding wall portion thereof; the shell having a plurality of connecting terminals fitted on an outer side thereof;
a wave filter circuit board positioned in the holding room of the shell; the wave filter circuit board having a plurality of grounding holes thereon;
a cover joined on the shell; the cover having a plurality of joining protrusions on a periphery thereof; the cover being positioned over the holding room of the shell with the joining protrusions thereof being embedded in corresponding said detainment gaps of the shell; and
a grounding component interposed between the wave filter circuit board and the cover; the grounding component having a plurality of grounding terminals, which are inserted in corresponding said grounding holes of the wave filter circuit board; the grounding component having a plurality of joining protrusions on a periphery thereof; the joining protrusions of the grounding component being embedded in corresponding said detainment gaps of the shell.

2. The wave filter structure as claimed in claim 1, wherein the cover has a plurality of propping and pressing pieces protruding downwards from a periphery thereof, which are inserted between the grounding component and the shell; each of the propping and pressing pieces having an elastic propping and pressing portion at a lower end.
